(19) United States
(12) Patent Application Publication
(10) Pub. No.: US 2025/0165953 A1
(43) Pub. Date: May 22, 2025

(54) ORDERING METHOD FOR RESTAURANT USING IDENTIFICATION CODE

(71) Applicant: IDP CORP., LTD., Seoul (KR)

(72) Inventor: Chang Bum KIM, Incheon (KR)

(21) Appl. No.: 19/029,268

(22) Filed: Jan. 17, 2025

Related U.S. Application Data
(63) Continuation of application No. PCT/KR2023/012301, filed on Aug. 18, 2023.

(30) Foreign Application Priority Data
Aug. 19, 2022 (KR) 10-2022-0103876

(51) Int. Cl. G06Q 20/32; G06Q 20/20; G06Q 50/12

(52) U.S. Cl. CPC G06Q 20/3276; G06Q 20/20; G06Q 50/12

(57) ABSTRACT

Described is an ordering method for a restaurant using an identification code to order, the method including: generating order identification information corresponding to each of a plurality of tables, generating the identification code including the order identification information, and transmitting the identification code to a code display installed on a corresponding table; by the order server, transmitting order details along with an order identification information contained in the identification code to the POS terminal, upon placing an order through the user terminal; by the POS terminal, receiving the order identification information and the order details, and identifying whether the order identification information received from the order server is valid; and by the POS terminal, receiving and processing the order details as valid upon the order identification information being valid, and preventing the order details from being received and processed upon the order identification information being invalid.

### CROSS REFERENCE TO RELATED APPLICATIONS

This application a continuation of International Application No. PCT/KR2023/012301 filed on Aug. 18, 2023, in the Korean Intellectual Property Receiving Office, which is based on and claims priority to Korean Application No. 10-2022-0103876 filed on Aug. 19, 2022, which are herein entirely incorporated by reference.

### TECHNICAL FIELD

The disclosure relates to a method of using an identification code to order at a restaurant, and more particularly to an unmanned ordering method of using an identification code such as a quick response (QR) code to place an order without a staff at a restaurant.

### BACKGROUND ART

Recently, restaurants and the like have been increasingly using kiosk or table ordering systems to reduce labor costs. The table ordering systems employ a tablet PC put on a table, a PC integrated into a table, or an identification code such as the QR code provided on the table, etc.

In the case of employing the tablet PC put on the table, there is a risk of losing or damaging the tablet PC. The PC integrated into the table has no risk of getting lost, but has disadvantages of being expensive and inconvenient because it is stationary. In the case of employing the QR code, it has advantages of low costs and no risks of loss and damage, but there is a risk of fraudulent orders because the QR code is static. To prevent such fraudulent orders, the QR code requires a series of complicated procedures, such as installing a dedicated app or joining a membership registration, and is thus inconvenient to use. Further, the ordering using the QR code is completed only after payment has been completed, and thus a user has to pay for each additional order, thereby causing inconvenience.

### DISCLOSURE

### Technical Problem

The disclosure has been conceived to solve the problems described as above, and an aspect of the disclosure is to provide a method of using an identification code to order at a restaurant, thereby preventing fraudulent orders. Another aspect of the disclosure is to provide a method of using an identification code to order at a restaurant, thereby providing an easy way to order without installing a dedicated app or joining a membership registration. Still another aspect of the disclosure is to provide a method of using an identification code to order at a restaurant, thereby allowing a user to pay when s/he wants rather than having to pay when ordering.

### Technical Solution

According to an aspect of the disclosure, an ordering method for a restaurant using an identification code to order includes: by a point-of-sale (POS) terminal installed in the restaurant, generating order identification information corresponding to each of a plurality of tables, generating the identification code including the order identification information, and transmitting the identification code to a code display installed on a corresponding table; by the code display, displaying the identification code; by an order server, providing a webpage for menu ordering to a user terminal, upon the user terminal scanning the identification code and accessing the order server corresponding to the identification code; by the order server, transmitting order details along with an order identification information contained in the identification code to the POS terminal, upon making a menu choice and placing an order through the user terminal; by the POS terminal, receiving the order identification information and the order details, and identifying whether the order identification information received from the order server is valid; and by the POS terminal, receiving and processing the order details as valid upon the order identification information being valid, and preventing the order details from being received and processed upon the order identification information being invalid.

The method may further include, by the POS terminal, notifying the order server that the ordering has been completed upon the order identification information being valid, and notifying the order server that the ordering has failed upon the order identification information is invalid.

The order identification information may include restaurant identification information, table identification information, and an order number; the identification code may include at least one of a bar code, a quick response (QR) code, a data matrix, a maxi code, and a PDF-417, and the method may further include, by the POS terminal, processing the corresponding order identification information and identification code as having already been used upon completed payment for the order details, and making new order identification information and a new identification code to be generated and transmitted to the code display.

The order number may be generated including a generation time or a random number, or includes a password key or an electronic signature.

The identifying whether the order identification information is valid may include, by the POS terminal, identifying that the order identification information is valid upon matching between the order identification information received from the order server and order identification information contained in a latest generated identification code for each table, and identifying that the order identification information is invalid upon non-matching between the order identification information received from the order server and the order identification information contained in the latest generated identification code for each table

The method may further include, by the order server, notifying the user terminal that the ordering has been completed or that the ordering has failed, based on notification received from the POS terminal

At least one of the POS terminal and the order server may combine and manage a previous order and a current order upon the previous order present corresponding to the received order identification information.

The method may further include: by the order server, providing a webpage, which includes items for checking, changing or paying for order details corresponding to the identification code, or calling a staff, to the user terminal accessed thereto through the identification code; and by the order server, transmitting an order change, a payment result, or a staff call, which is input through the user terminal, to the POS terminal.

The method may further include, by the POS terminal, transmitting the order details and a message that the ordering has been completed to the code display installed on the table corresponding to the ordering upon the valid order identification information being received and processed, and transmitting a message that the ordering has failed to the code display installed on the table corresponding to the order identification information upon the invalid order identification information.

The POS terminal may include: a code generator configured to generate the order identification information and the identification code; a memory configured to store information about the identification code and the order identification information generated by the code generator; and a controller configured to control the order identification information and the identification code to be processed as having already been used in the memory upon the completed payment for the ordering, control the code generator to generate new order identification information and a new identification code, and control the memory to store the generated order identification information and identification code as valid identification information.

### Advantageous Effects

As described above, a method of using an identification code to order at a restaurant according to the disclosure identifies whether order identification information is valid, thereby preventing fraudulent orders. Further, it is easy to place an order without installing a dedicated app or joining a membership registration. In addition, a user is not forced to pay when ordering and is thus allowed to make, for example, a prepayment, an intermediate payment, or a post payment as desired.

### DESCRIPTION OF DRAWINGS

FIG. 1 is a schematic diagram of an unmanned ordering system using an identification code according to an embodiment of the disclosure.

FIG. 2 is a schematic diagram of a point-of-sale (POS) terminal according to an embodiment of the disclosure.

FIG. 3 is a flowchart showing an ordering method of an unmanned ordering system using an identification code according to an embodiment of the disclosure.

FIG. 4 is a flowchart showing an ordering method of an unmanned ordering system using an identification code according to an embodiment of the disclosure.

### BEST MODE

Below, specific embodiments of the disclosure will be described with reference to the accompanying drawings.

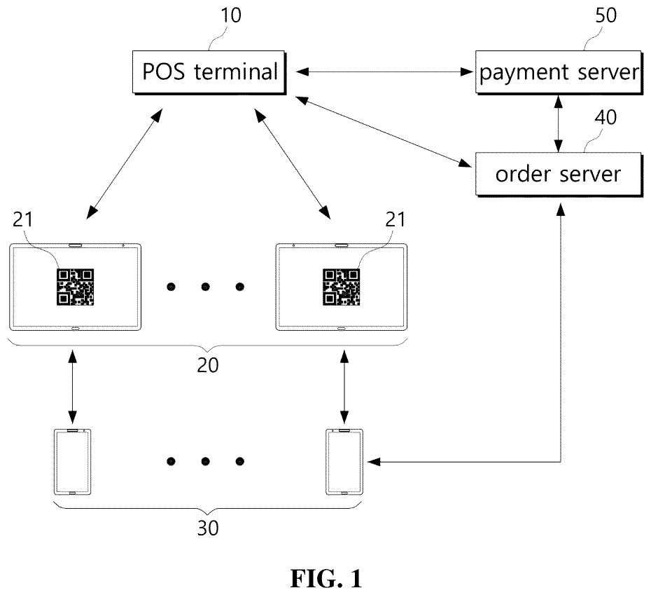

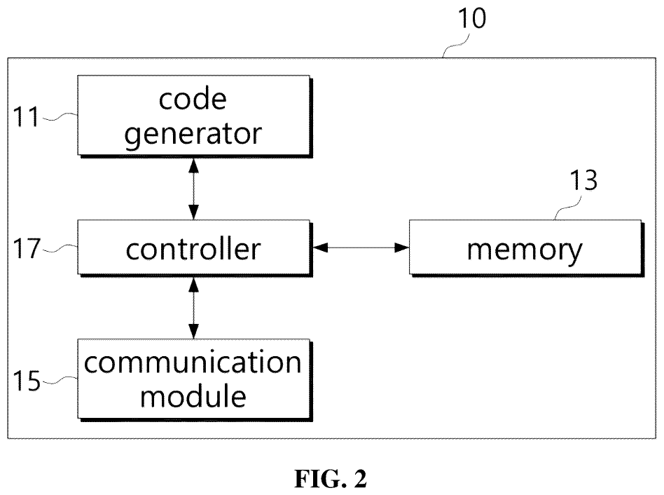

FIG. 1 is a schematic diagram of an unmanned ordering system using an identification code according to an embodiment of the disclosure, and FIG. 2 is a schematic diagram of a point-of-sale (POS) terminal 10 according to an embodiment of the disclosure. Referring to FIG. 1, the unmanned ordering system using the identification code according to an embodiment of the disclosure includes the POS terminal 10 installed in a store, a code display 20 installed for each table, a user terminal 30, and an order server 40.

The POS terminal 10 installed in the store is to process order management, payment, etc., and means a point-of-sale information management system. The POS terminal (or POS system) 10 refers to a terminal that performs an electronic cash register function, a computer function, etc. to automatically collect and record data about sales management generally at a point in time of selling a product and then analyze and process various pieces of necessary data to be directly or indirectly reflected in store operations, thereby preventing time and financial losses. To perform these functions, the POS terminal 10 has a register function like a cash register, a file function to temporarily record data, and an online communication function to access an upper device (e.g., headquarters host computer, etc.) and transmit data to the upper device at the sales point in time. The POS terminal 10 described in this specification may be referred to as a POS system comprehensively encompassing a plurality of terminals, or may of course be replaced by the POS system. The POS terminal 10 may be implemented by a computing device that includes a memory to store a series of data and computer program codes for performing the POS functions, a processor to execute the computer program codes, and a communication module.

The POS terminal 10 processes a customer's order, payment, etc. from a table while interworking with the code display 20 installed at each table and the order server 40. Specifically, the POS terminal 10 generates order identification information corresponding to each of a plurality of tables and identification code including the order identification information and transmits them to the code display 20 installed in the corresponding table.

Here, the identification code includes at least one of a bar code, a quick response (QR) code, a data matrix, a maxi code, and a PDF417. In the following embodiments of the disclosure, it will be described by way of example that the identification code is implemented by the QR code.

The order identification information refers to information for identifying an order, and includes restaurant identification information, table identification information, and an order number. The restaurant identification information refers to the identification (ID) of a restaurant, and the table identification information refers to the identification information of a table placed in the restaurant. The order number refers to a number for identifying the order, and may be based on an order number generation time, a random number, a password, an electronic signature, etc. to avoid duplication and make guessing difficult.

The order identification information and the QR code are newly generated whenever an order, a payment or a table turnover is made. In this embodiment, the order identification information and the QR code are newly generated for example each time when the payment is made. Meanwhile, the QR code includes uniform resource locator (URL) information about an order web page.

The code display 20 installed on each table and displaying the QR code transmitted from the POS terminal 10 may be implemented as a small display such as a tablet PC having a communication function for interworking with the POS terminal 10. To reduce the volume and power consumption of the code display 20, electronic ink or the like may be used. Meanwhile, according to an embodiment of the disclosure, the POS terminal 10 may transmit order details or order status to the code display 20, and the code display 20 may display the order details or order status (e.g., order reception, cooking, serving, serving completed, etc.) as well as the QR code received from the POS terminal 10 so that the order details or order status can be checked. The code display 20 may include a simple program for QR code display and order confirmation, so that a user can control the operation of the code display 20 by making a choice from a menu as desired.

A computer program installed in the POS terminal 10 and implementing the method according to the disclosure provides a setting menu for the settings of the table and the settings of the code display 20, so that a user can input and set the location, number, etc. of the table through the setting menu. Of course, such a table setting function may also be implemented by a computer program installed in the code display 20.

When a user (e.g., restaurant customer) uses his or her own user terminal 30 (e.g., smartphone) to scan the identification code, e.g., the QR code displayed on the code display 20, the user terminal 30 recognizes an order URL contained in the QR code and accesses the order server 40 through the corresponding order URL, thereby allowing him/her to order a desired menu. For example, the corresponding order URL link may be provided so that a user can access the order server 40 through the provided link. The user terminal 30 may include a mobile terminal such as a smartphone or a tablet PC, and the like terminal in which a program capable of recognizing the QR code is installed.

The order server 40, which is to receive, process, and manage restaurant menu orders through the user terminal 30, may be implemented by a computing device that includes a memory to store data and computer program codes, a processor to execute the computer program codes, and a communication module. Further, the order server 40 is implemented including a web server and/or a database server. The user terminal 30 accesses the order server 40 through the QR code, and the order server 40 provides a restaurant's menu order page corresponding to a URL to the user terminal 30. When the user terminal 30 completes ordering a menu, the order server 40 transmits the order details and the order identification information contained in the QR code to the POS terminal 10. Meanwhile, the order server 40 may implement a payment function for the order details by interworking a payment server 50.

The payment server 50 refers to a server that processes payment through credit card payment or direct debit, and may be implemented including a relay server, a card company server, and a bank server.

The POS terminal 10 will be described in more detail with reference to FIG. 2. Referring to FIG. 2, the POS terminal 10 includes a code generator 11, a memory 13, a communication module 15, and a controller 17. The code generator 11 is to generate the order identification information corresponding to each of a plurality of tables placed in a restaurant and to generate the QR code containing the order identification information. The code generator 11 may be implemented with a code generation algorithm, and may include a random number generator, an encryptor, etc.

The memory 13 is configured to store information about the order identification information and QR code generated by the code generator 11, in which the stored information may include a generation time of the order identification information and QR code, order details, and payment details. In addition, the information stored in the memory 13 includes information about whether the order identification information and the QR code is currently valid or has already been used (e.g., payment has been done).

The communication module 15 is to communicate with the code display 20 and the order server, and may be implemented with various wireless and wired communication modules such as Ethernet, Wi-Fi, Bluetooth, near field communication (NFC), Zigbee, infrared ray (IR), radio frequency (RF), 3G LTE, and 5G.

The controller 17 is responsible for overall control of the POS terminal 10, and may be implemented including a control program code stored in the memory 13 and a processor for executing the control program code. The controller 17 controls the order identification information and QR code generated by the code generator 11 to be stored in the memory 13 and controls the generated QR code to be transmitted to the corresponding code display 20 installed in the table.

When the payment for the order details is done, the controller 17 processes the corresponding QR code in the memory 13 as having already been used, controls the code generator 11 to generate new order identification information and a new QR code, and updates and stores the memory 13 with the new order identification information and new QR code generated by the code generator 11 as valid information. For example, the QR code with which the payment has been done is processed as having already been used and flagged as invalid information, and the new order identification information and new QR code generated corresponding to that table become as a valid order identification information and a valid QR code. In other words, only the latest order identification information and QR code for each table are stored as the valid information, and the order identification information and QR code with which the payment has been done are treated as the invalid information. When the order identification information in the order details transmitted from the order server 40 does not match the latest valid order identification information stored in the memory 13, the order is identified as fraudulent and processed not to be received. On the other hand, when the order identification information in the order details transmitted from the order server 40 matches the latest valid order identification information stored in the memory 13, the order is identified as legitimate and processed to be received.

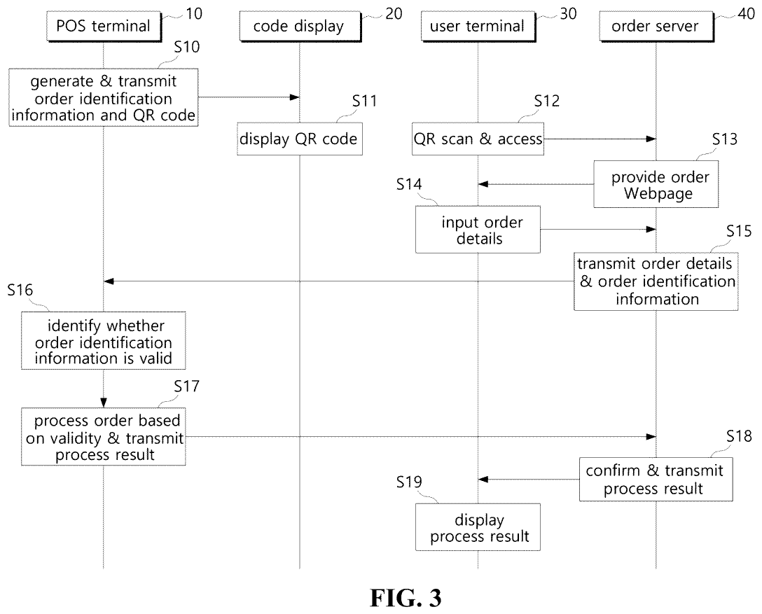

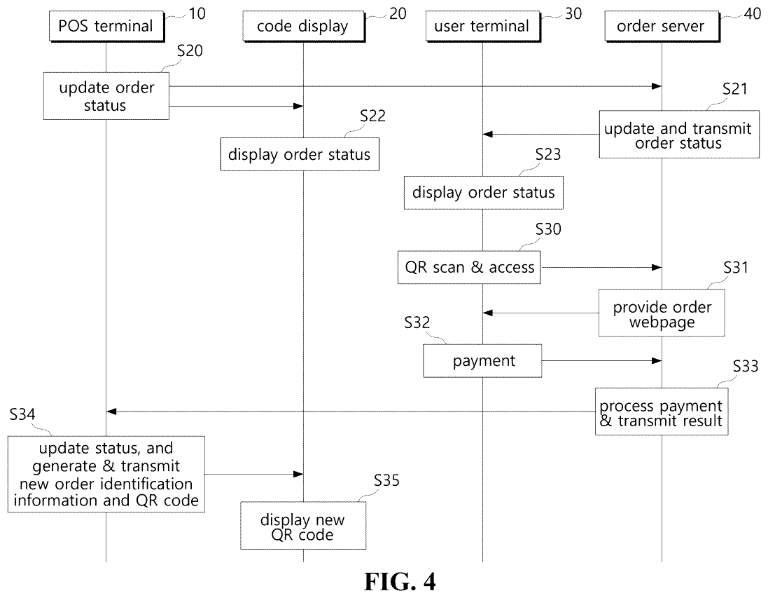

The ordering method of the unmanned ordering system using the QR code according to an embodiment of the disclosure will be described with reference to FIGS. 3 and 4. Repetitive descriptions to the foregoing embodiment will be avoided as necessary.

FIGS. 3 and 4 are flowcharts showing an ordering method of an unmanned ordering system using an identification code according to an embodiment of the disclosure. Referring to FIG. 3, when a restaurant opens, the POS terminal 10 generates the order identification information and the QR code corresponding to each table, stores them in the memory 13, and transmits each QR code to the code display 20 installed on the corresponding table (S10). As described above, the order identification information includes the restaurant identification information, the table identification information, and the order number, and the QR code includes the order identification information and the order URL. According to the disclosure, to prevent the fraudulent use of the QR code, the POS terminal 10 may generate an encryption key, a random number, an electronic signature, a timestamp, etc. to be included in the order number.

The code displays 20 installed on the plurality of tables in the restaurant display the QR codes received from the POS terminal 10 thereon, respectively (S11). The QR codes displayed on the code displays 20 are different from each other, and a customer at the table uses his/her own terminal to scan the QR code displayed on the code display 20 and to access the order server 40 through the order URL included in the QR code (S12). The order server 40 receives the order identification information contained in the QR code from the user terminal 30, and provides a web page corresponding to the order URL for ordering a restaurant menu to the user terminal 30 (S13). When the customer inputs order details by making a choice from the menu as desired through the webpage displayed on the user terminal 30 for the restaurant menu ordering (S14), the order server 40 transmits the order identification information contained in the QR code along with the order details input by the customer to the POS terminal 10 (S15).

The POS terminal 10 receives the order details and the order identification information from the order server 40, checks whether the order identification information is valid, and identifies whether the order is legitimate (S16). Then, the order is processed to be received according to whether the order identification information is valid, and an order processing result is transmitted to the order server 40 (S17). For example, when the order identification information transmitted from the order server 40 and received in the POS terminal 10 matches the latest valid order identification information stored in the memory 13, the order details are identified as valid and processed to be validly received and the order server 40 is notified that the ordering has been completed. The order server 40 transmits a message that the ordering has been completed from the POS terminal 10 to the user terminal 30 (S18), and the user terminal 30 displays the message received from the order server 40 as a push notification (S19). Accordingly, a user can know that his/her ordering has been completed.

On the other hand, when the order identification information transmitted from the order server 40 and received in the POS terminal 10 does not match the latest valid order identification information stored in the memory 13, the order details are identified as invalid and fraudulent and the order server 40 is notified that the ordering has failed. The order server 40 transmits a message that the ordering has failed from the POS terminal 10 to the user terminal 30 (S18), and the user terminal 30 displays the ordering failure message received from the order server 40 as a push notification (S19). Accordingly, a user can know that his/her ordering has failed. When the ordering has failed despite the user's legitimate order using the QR code displayed on the code display 20, the user may ask the restaurant's staff to solve an ordering error or the like problem.

Referring to FIG. 4, the POS terminal 10 may update order status after receiving the order and transmit the order status to the order server 40 and/or the code display 20 (S20). The order server 40 updates the order status and transmits it to the user terminal 30 (S21), and the code display (20) displays the order status received from the POS terminal 10 (S22). For example, when a POS system of a restaurant includes a first terminal used for order reception and payment, and a second terminal installed in a kitchen, order details are shared with both the first terminal and the second terminal after the order reception. Whenever the order status such as order reception, cooking, serving, and serving completed is updated as input or processed at the first terminal or the second terminal, information about the updated order status may be transmitted to the order server 40 and/or the code display 20. Accordingly, a user can check in real time what stage his/her order status is in 1through the user terminal 30 and/or the code display 20.

On the other hand, when a customer scans the QR code displayed on the code display 20 again and accesses the order server 40 again (S30), the order server 40 may provide the webpage for the ordering to the user terminal 30 (S31), in which the webpage provided by the order server may include items for checking or changing the order details, paying for an order or calling a staff. Through the webpage displayed on the user terminal 30, the customer may check or change the order details, pay for an order, or call a staff. For example, when the customer accesses the order server 40 and pays for an order (S32), the order server 40 may process the payment by interworking with the payment server 50 and transmit a processing result to the POS terminal 10 (S33). The POS terminal 10 confirms the payment result received from the order server 40, processes the corresponding order identification information and QR code as having already been used, generates new order identification information and a new QR code corresponding to that table, updates the memory 13 with the new order identification information and the new QR code as valid information, and transmits the new order identification information and the new QR code to the code display 20 (S34). The code display 20 displays the new QR code received from the POS terminal 10 thereon (S35). As a result, the order identification information and QR code with which the payment has been done are flagged as invalid information, and the latest order identification information and QR code newly generated are used in updating as valid information. When an order is received using the QR code with which the payment has already been done, the POS terminal 10 identifies the order as a fraudulent order and does not receive the order. In this way, the order identification information and the QR code according to the disclosure are newly generated whenever an order, a payment or a table turnover is made, and their matching is checked when receiving an order, thereby solving a conventional problem of accessing a static QR code and placing a fraudulent order.

As another example, when a customer scans the QR code displayed on the code display 20 again and accesses the order server 40 again to place an additional order, the order server 40 and/or the POS terminal 10 combines and manages the previous order and the current order. Therefore, a customer can pay for multiple orders at once. In this case, the payment may be made through the user terminal 30 or the POS terminal 10. In this way, unlike the conventional technology that forces prepayment, the disclosure has an advantage of allowing a customer to freely make payments at any time s/he wants, such a prepayment, an intermediate payment, and a post payment.

Although all elements for an embodiment of the disclosure are combined as one or operating as combined, the disclosure is not limited to this embodiment. In other words, one or more elements among all the elements may be selectively combined and operated as long as they fall into the scope of the disclosure. Further, all the elements may be respectively implemented by independent pieces of hardware, or some or all of the elements may be selectively combined and thus implemented as a computer program having a program module that performs the functions of some or all combinations from one or multiple pieces of hardware. Codes and code segments constituting that computer program may be easily deduced by those skilled in the art. Such a computer program is stored in a computer readable medium and read and executed by a computer, thereby implementing the embodiments of the disclosure. The storage medium of the computer program may include a magnetic recording medium, an optical recording medium, etc.

Further, the terms “comprise,” “configure” and/or “have” specify the presence of stated components, unless there is a clearly different meaning in the disclosure, but do not preclude the presence thereof and should be construed to further include other components. Unless otherwise defined, all terms including technical or scientific terms used herein have the same meaning as commonly understood by those skilled in the art to which the disclosure pertains. General terms that are defined in a dictionary shall be construed to have meanings that are consistent in the context of the relevant art, and will not be interpreted as having an idealistic or excessively formalistic meaning unless clearly defined in the disclosure.

The foregoing description is merely an example of technical idea according to the disclosure, and various modifications and changes can be made by a person having ordinary knowledge in the art to which the disclosure pertains without departing from the essential characteristics of the disclosure. Accordingly, the embodiments of the disclosure are not intended to limit but rather to describe the technical idea of the disclosure, and the scope of the technical idea of the disclosure is not limited by these embodiments. The scope of the disclosure should be interpreted based on the appended claims, and all technical ideas within the equivalent scope should be interpreted as falling into the scope of the disclosure.

What is claimed is:

1. An ordering method for a restaurant using an identification code to order, the method comprising:
by a point-of-sale (POS) terminal installed in the restaurant, generating order identification information corresponding to each of a plurality of tables, generating the identification code comprising the order identification information, and transmitting the identification code to a code display installed on a corresponding table;
by the code display, displaying the identification code;
by an order server, providing a webpage for menu ordering to a user terminal, upon the user terminal scanning the identification code and accessing the order server corresponding to the identification code;
by the order server, transmitting order details along with an order identification information contained in the identification code to the POS terminal, upon making a menu choice and placing an order through the user terminal;
by the POS terminal, receiving the order identification information and the order details, and identifying whether the order identification information received from the order server is valid; and
by the POS terminal, receiving and processing the order details as valid upon the order identification information being valid, and preventing the order details from being received and processed upon the order identification information being invalid.

2. The method of claim 1, further comprising, by the POS terminal, notifying the order server that the ordering has been completed upon the order identification information being valid, and notifying the order server that the ordering has failed upon the order identification information is invalid.

3. The method of claim 1, wherein:
the order identification information comprises restaurant identification information, table identification information, and an order number;
the identification code comprises at least one of a bar code, a quick response (QR) code, a data matrix, a maxi code, and a PDF-417, and
the method further comprising, by the POS terminal, processing the corresponding order identification information and identification code as having already been used upon completed payment for the order details, and making new order identification information and a new identification code to be generated and transmitted to the code display.

4. The method of claim 3, wherein the order number is generated comprising a generation time or a random number, or comprises a password key or an electronic signature.

5. The method of claim 3, wherein the identifying whether the order identification information is valid comprises, by the POS terminal, identifying that the order identification information is valid upon matching between the order identification information received from the order server and order identification information contained in a latest generated identification code for each table, and identifying that the order identification information is invalid upon non-matching between the order identification information received from the order server and the order identification information contained in the latest generated identification code for each table.

6. The method of claim 5, further comprising, by the order server, notifying the user terminal that the ordering has been completed or that the ordering has failed, based on notification received from the POS terminal.

7. The method of claim 1, wherein at least one of the POS terminal and the order server combines and manages a previous order and a current order upon the previous order present corresponding to the received order identification information.

8. The method of claim 3, wherein at least one of the POS terminal and the order server combines and manages a previous order and a current order upon the previous order present corresponding to the received order identification information.

9. The method of claim 7, further comprising:
by the order server, providing a webpage, which comprises items for checking, changing or paying for order details corresponding to the identification code, or calling a staff, to the user terminal accessed thereto through the identification code; and
by the order server, transmitting an order change, a payment result, or a staff call, which is input through the user terminal, to the POS terminal.

10. The method of claim 8, further comprising:
by the order server, providing a webpage, which comprises items for checking, changing or paying for order details corresponding to the identification code, or calling a staff, to the user terminal accessed thereto through the identification code; and
by the order server, transmitting an order change, a payment result, or a staff call, which is input through the user terminal, to the POS terminal.

11. The method of claim 1, further comprising, by the POS terminal, transmitting the order details and a message that the ordering has been completed to the code display installed on the table corresponding to the ordering upon the valid order identification information being received and processed, and transmitting a message that the ordering has failed to the code display installed on the table corresponding to the order identification information upon the invalid order identification information.

12. The method of claim 3, further comprising, by the POS terminal, transmitting the order details and a message that the ordering has been completed to the code display installed on the table corresponding to the ordering upon the valid order identification information being received and processed, and transmitting a message that the ordering has failed to the code display installed on the table corresponding to the order identification information upon the invalid order identification information.

13. The method of claim 1, wherein the POS terminal comprises:
a code generator configured to generate the order identification information and the identification code;
a memory configured to store information about the identification code and the order identification information generated by the code generator; and
a controller configured to control the order identification information and the identification code to be processed as having already been used in the memory upon the completed payment for the ordering, control the code generator to generate new order identification information and a new identification code, and control the memory to store the generated order identification information and identification code as valid identification information.

14. The method of claim 3, wherein the POS terminal comprises:
a code generator configured to generate the order identification information and the identification code;
a memory configured to store information about the identification code and the order identification information generated by the code generator; and
a controller configured to control the order identification information and the identification code to be processed as having already been used in the memory upon the completed payment for the ordering, control the code generator to generate new order identification information and a new identification code, and control the memory to store the generated order identification information and identification code as valid identification information.
